(19) United States
(12) Patent Application Publication
(10) Pub. No.: US 2024/0246391 A1
(43) Pub. Date: Jul. 25, 2024

(54) METHOD AND SYSTEM FOR ADAPTIVE CABIN AIR QUALITY CONTROL

(71) Applicant: THE REGENTS OF THE UNIVERSITY OF CALIFORNIA, Oakland, CA (US)

(72) Inventors: Heejung Jung, Irvine, CA (US); Herve Borrel, Scottsdale, AZ (US)

(73) Assignee: THE REGENTS OF THE UNIVERSITY OF CALIFORNIA, Oakland, CA (US)

(21) Appl. No.: 18/417,010

(22) Filed: Jan. 19, 2024

Related U.S. Application Data
(60) Provisional application No. 63/480,769, filed on Jan. 20, 2023.

(51) Int. Cl. B60H 1/00

(52) U.S. Cl. CPC B60H 1/008; B60H 1/00849

(57) ABSTRACT

A method and system are disclosed for adaptive cabin air quality control. The method includes: collecting, on a computer processor, data from one or more air quality sensors; calculating, by the computer processor, a pollution level for one or more grid locations; receiving, by the computer processor, a location for a vehicle within the one or more grid locations, the vehicle including an air cabin air recirculation system with a controllable air flap; calculating, by the computer processor, a real-time flap position for the controllable air flap based on the pollution for the one or more grid locations and the location for the vehicle within the one or more grid locations; and sending, by the computer processor, the real-time flap position to the vehicle.

### CROSS REFERENCE TO RELATED APPLICATIONS

This application claims the benefit of U.S. Provisional Application 63/480,769, filed Jan. 20, 2023, which is incorporated by reference in its entirety.

### TECHNICAL FIELD

The present disclosure generally relates to a method and system for adaptive cabin air quality control, and more particularly to a method and system for adaptive air quality control using a real-time air quality control map with and without an on-board air quality sensor (AQS) on an automotive vehicle.

### BACKGROUND

U.S. Patent No. 10,887,722 B2 entitled “Traffic Pollution Mapper” discloses a method that may utilize various sensors to detect pollution, including automotive air quality sensors that provide binary open and close signals.

### SUMMARY

It would be desirable to have a system and method that can continuously controls the recirculation flap door at various angles (or openings) using one or more of an open-loop control mechanism or a closed-loop control mechanism.

In accordance with an embodiment, a method is disclosed for adaptive cabin air quality control, the method comprising: collecting, on a computer processor, data from one or more air quality sensors; calculating, by the computer processor, a pollution level for one or more grid locations; receiving, by the computer processor, a location for a vehicle within the one or more grid locations, the vehicle including an air cabin air recirculation system with a controllable air flap; calculating, by the computer processor, a real-time flap position for the controllable air flap based on the pollution for the one or more grid locations and the location for the vehicle within the one or more grid locations; and sending, by the computer processor, the real-time flap position to the vehicle.

In accordance with an embodiment, a system is disclosed for adaptive cabin air quality control, the system comprising: a processor configured to: collect data from one or more air quality sensors; calculate a pollution level for one or more grid locations; receive a location for a vehicle within the one or more grid locations, the vehicle including an air cabin air recirculation system with a controllable air flap; calculate a real-time flap position for the controllable air flap based on the pollution for the one or more grid locations and the location for the vehicle within the one or more grid locations; and send the real-time flap position to the vehicle.

### BRIEF DESCRIPTION OF THE DRAWINGS

FIG. 1 is an illustration of a system for adaptive cabin air quality control in accordance with an embodiment.

FIG. 2 is a flowchart illustrating a method for adaptive cabin air quality control in accordance with an embodiment.

FIG. 3 is an illustration of an automobile with an air quality sensor (AQS) in accordance with an embodiment.

FIG. 4 is an illustration of a recirculation flap in a closed positioned in accordance with an embodiment.

FIG. 5 is an illustration of a recirculation flap in a partially opened state in accordance with an embodiment.

FIG. 6 is an illustration of a recirculation flap in an open state in accordance with an embodiment.

FIG. 7 is an illustration of a circuit for adaptive cabin air quality control in accordance with an embodiment.

FIG. 8 is flowchart of method for adaptive cabin air quality control in accordance with an embodiment.

FIG. 9 is an illustration of an exemplary hardware architecture for an embodiment of a computer system.

### DETAILED DESCRIPTION

Set forth below with reference to the accompanying drawings is a detailed description of embodiments of method and system for adaptive cabin air quality control. Note that since embodiments described below are preferred specific examples of the present disclosure, although various technically preferable limitations are given, the scope of the present disclosure is not limited to the embodiments unless otherwise specified in the following descriptions.

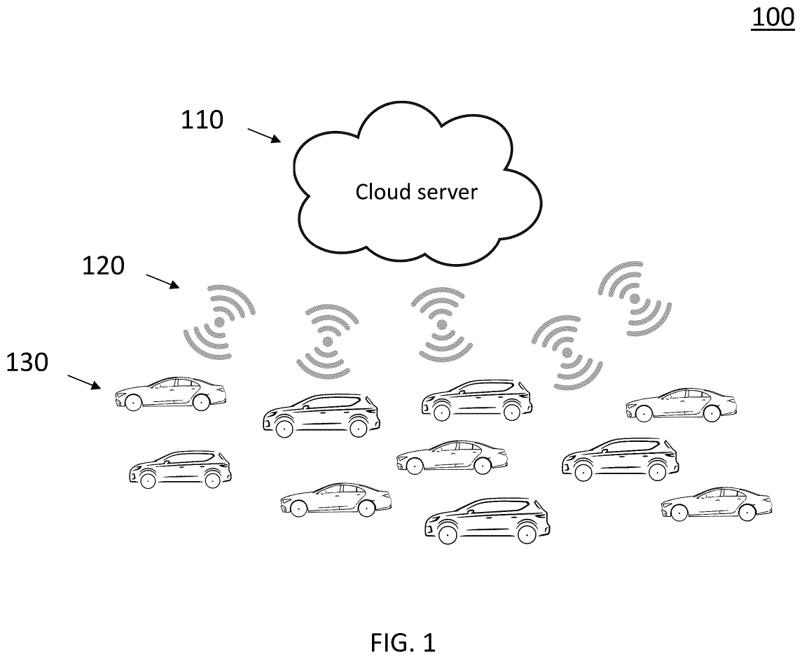

FIG. 1 is an illustration of a system 100 for adaptive cabin air quality control in accordance with an embodiment. As shown in FIG. 1, the system 100 can include a cloud server 110, a plurality of automotive vehicles (or vehicles) 130, and a communication link 120 between the cloud server 110 and the plurality of vehicles 130. The cloud server 110 can be configured to receive on-road air quality, for example, from air quality sensors in one or more of the plurality of vehicles 130.

In accordance with an embodiment, the system 100 can incorporate a spatiotemporally resolved on-road air quality map, for example, realized by a network of mobile air quality sensors, for example, mobile air quality sensors that can adaptively control cabin air quality. For example, if the vehicle is not equipped with air quality sensor, an air quality map along the drive route of the vehicle can be used to control vehicle air quality by continuously controlling the recirculation flap door at various angles (or openings) using one or more of an open-loop control mechanism (i.e., non-feedback controlled system) or a closed-loop control mechanism (i.e., feedback controlled system). Alternatively, if the vehicle is equipped with an air quality sensor, the system and method disclosed herein can use the cabin air quality control system in combination with the on-board sensor information with the map information to be both reactive to unpredictable pollution events, and for prevention in areas or locations within the one or more grid locations that the one or more vehicles may encounter, for example, with more repeatable pollution. In accordance with an embodiment, the method and system as disclosed can provide a signal that prevents the on-board sensor in the vehicle from recommending a flap re-opening just ahead, for example, of a high pollution area.

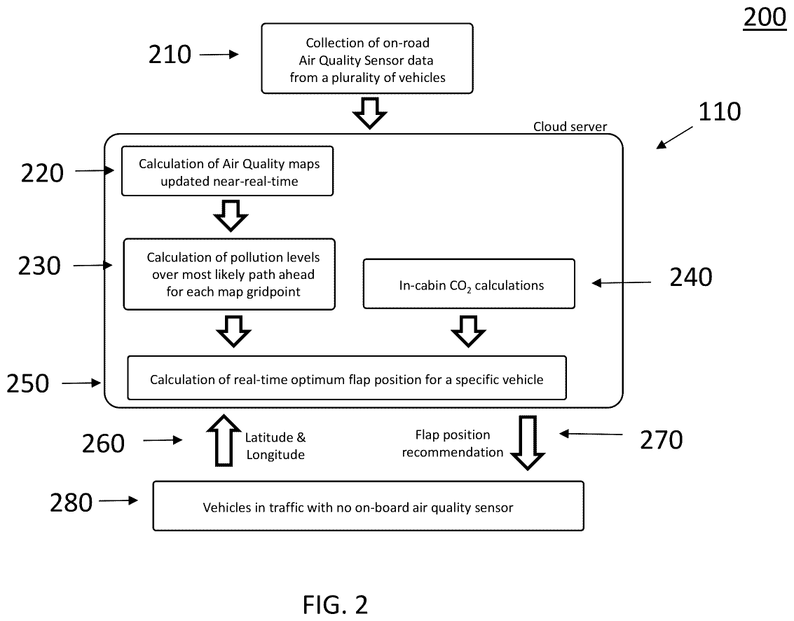

FIG. 2 is a flowchart illustrating a method 200 for adaptive cabin air quality control in accordance with an embodiment. As shown in FIG. 2, in step 210, on-road air quality sensor data is collected from a plurality of vehicles. In step 220, one or more air quality maps can be updated in real-time (i.e., near real-time) from the collection of the on-road air quality data from step 210 from the plurality of vehicles 130. In step 230, pollution levels over a most likely path for each grid point on the map can be calculated. In step 240, in-cabin CO₂ (carbon dioxide) information is received by the cloud server 110. In step 250, a real-time calculation of a flap position (i.e., real-time optimum flap position) for an intake system for each of the plurality of vehicles 130 can be calculated. In step 260, latitude and longitude for one or more of the plurality of vehicle can be received by the cloud server 110 from one or more vehicles in traffic without on-board air quality sensor 280. In step 270, a flap position recommendation can be sent to one or more of the plurality of vehicles 130 based on the calculation of the real-time optimum flap position can be sent to the one or more vehicles without an on-board air quality sensor 280.

In accordance with an embodiment, the instantaneous air quality sensor information coupled with the predictive map information can allow a more efficient flap open close time management and allows the vehicle the ability to minimize the number of flap movements. It should be noted as the vehicle is in motion and there is a spatial resolution of air quality map, a comparison algorithm can be included. The comparison algorithm can compare readings from the on-board sensor and the air quality map. For example, if the comparison algorithm determines the on-board sensor and the air quality map agree in terms of outside air pollutant concentrations, the control system can instruct the recirculation flap door to close preemptively before the on-board air quality sensor (AQS) detects air pollutant concentrations higher than the threshold, which allows for more protective vehicle cabin air quality control. If the comparison algorithm finds the air pollutant concentration between on-board AQS and air quality map is different, then the comparison algorithm can use the data which reports higher pollutant concentrations to be more protective.

It should be noted, for example, if there is time delay, for example, of from 10 seconds (s) to 3 minutes (min) in receiving air quality sensor information that can also be taken into account based on server's computing power and by using an algorithm between the air quality concentration in the map and from the on-board air quality sensor (AQS). The map information can help alleviate a sensor-flap loop weakness, which is that the sensor may only detect pollution once it is entering the cabin, and then the flap takes, for example, 2 seconds to 5 seconds to close. The method and system as disclosed herein can include control of flap door opening in partial closure position to minimize wear on the flap actuator and to prevent accumulation of in-cabin CO₂ concentration.

In accordance with an embodiment, the control of the flap door (i.e., a flap management strategy) can be based on a plurality of variables including pollution (or harmful materials in the environment) that the vehicle is likely to go through, for example, in the coming few minutes, for example, 2 minutes to 30 minutes. The air quality map information can be used to determine the likely pollution for the likely path of the vehicle. To obtain a likely path, or most likely path of the vehicle, a predictive path algorithm can be used. The predictive path algorithm can, for example, calculate the most likely next vehicle locations for any location during the trip, based on the history of trips used to build the air quality maps

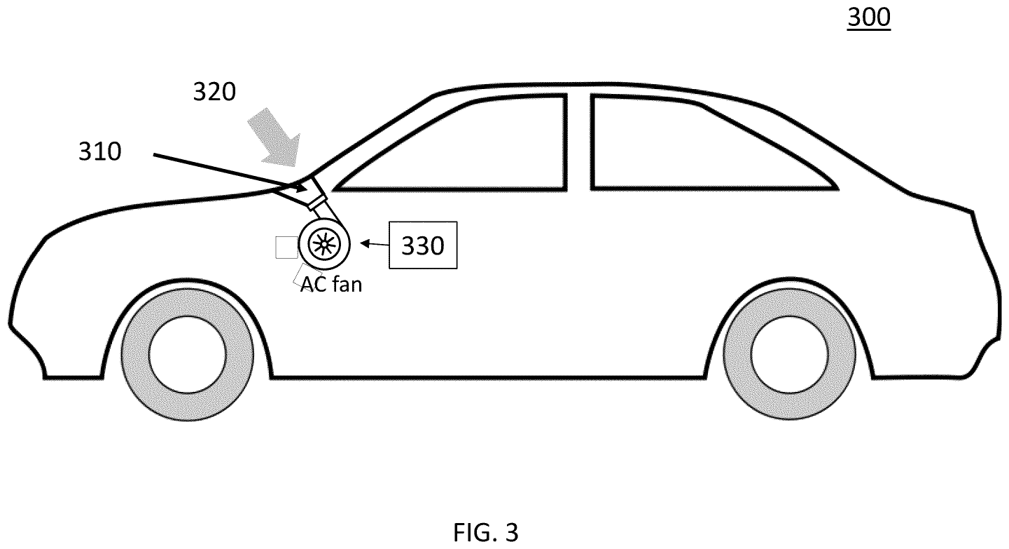

FIG. 3 is an illustration of a vehicle (or automobile) 300 with an air quality sensor 310 (AQS) in accordance with an embodiment. As shown in FIG. 3, the air quality sensor 310 (AQS) can be located in the cabin air intake 320 of the vehicle 300. The air quality sensor 310 can be located in front of the air conditioning (AC) fan 330.

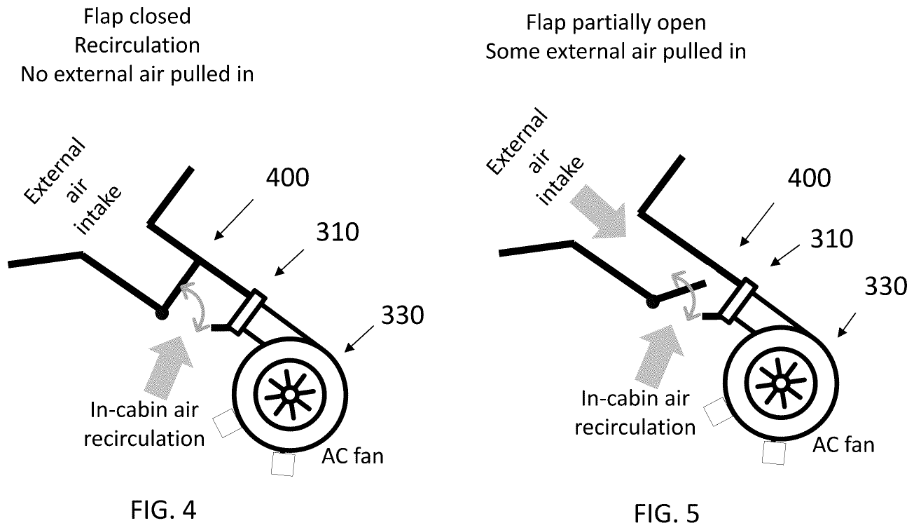

FIG. 4 is an illustration of a recirculation flap 400 in a closed positioned in accordance with an embodiment. As shown in FIG. 4, in the closed position, no external air is pulled into the cabin of the vehicle 300 by the AC fan 330. Instead, the cabin of the vehicle will experience in-cabin air recirculation by the AC fan 330.

FIG. 5 is an illustration of a recirculation flap 400 in a partially opened state in accordance with an embodiment. As shown in FIG. 5, in the partially opened position, external air (at least some external air) can be pulled into vehicle cabin in combination with in-cabin air recirculation by the AC fan 330.

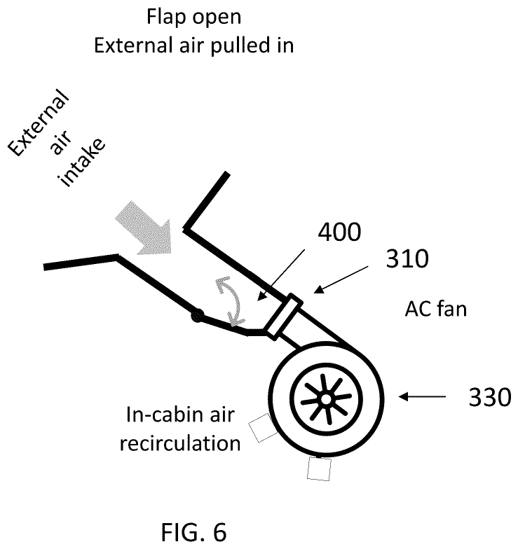

FIG. 6 is an illustration of a recirculation flap 400 in an open state in accordance with an embodiment. As shown in FIG. 6, external air can be pulled into the cabin of the vehicle with the AC fan 330. In addition, there is no recirculation of the in-cabin air by the AC fan 330.

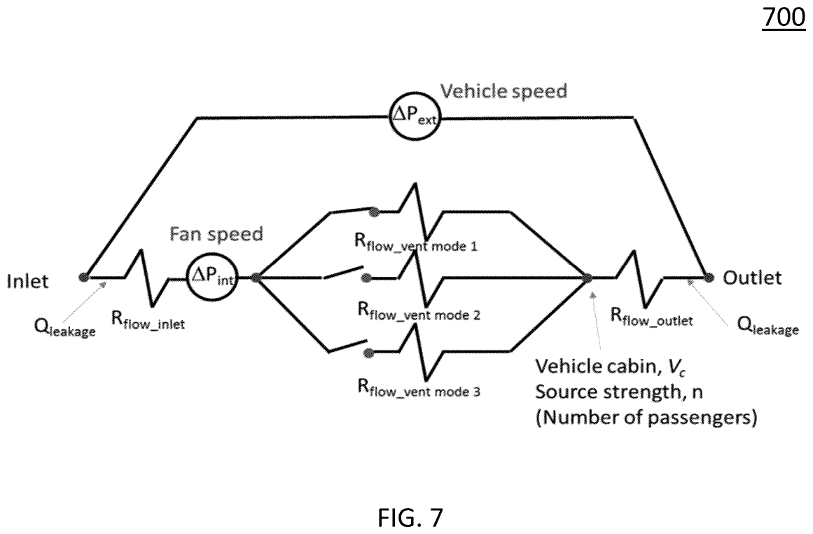

FIG. 7 is an illustration of a system 700 for adaptive cabin air quality control in accordance with an embodiment. As shown in FIG. 7, the system 700 can be configured to receive one or more inputs including vehicle speed 710 and fan speed 720 with one or more vent flow modes 730, 732, 734. The system 700 can calculate an inlet flow (R_{flow_inlet}) 702, the fan speed 720, the one or more vent flow modes 730, 732, 734, and an outlet flow (R_{flow_outlet}) 706. The one or more vent flow modes 730, 732, 734, can include, for example, the recirculation flap door (or flap door) in a closed positioned 730, the recirculation flap door (or flap door) a partially opened state 732, or the recirculation flap door (or flap door) 734 in open state. In addition, the system 700 can also calculate an inlet flow leakage (Q_{leakage}) 704 and an outlet flow leakage (Q_{leakage}) 708. In addition, the system 700 can include one or more components associated with the vehicle cabin 740 including, for example, cabin volume (V_{c}) 742 and number of passengers within the vehicle cabin (n) 744.

In accordance with an embodiment, the system 700 can include an open-loop control feature in which the recirculation flap door angle is controlled as a function of vehicle speed 710, number of passengers 744 which can be estimated, for example, by weight sensors embedded in the seat, cabin volume 742, fan speed 720 (e.g., percentage of flap door opening). In accordance with an embodiment, a threshold for the in-cabin CO₂ concentration can be determined so that the flap door can be closed and opened so as not to exceed the threshold of the in-cabin CO₂ concentration. For example, the more closed the flap door (i.e., smaller percentage of the opening of the flap within the external air intake), the less the concentration of the in-cabin pollutants (particles, NO₂ and O₃) that can be brought into the cabin of the vehicle. In addition, to help reduce NO (nitric oxide) concentrations in the cabin of the vehicle, an adsorption type filter may be used in the cabin intake 320 of the vehicle 300.

In applying an open-loop control, a different criteria can be applied. For example, an on-and-off control of the flap door can shorten the lifetime of the actuator and may not be ideal. For each set of input conditions (for example, number and weight of passengers, fan speed, vehicle speed, and cabin volume), one or more specific setting corresponding to a percentage of the opening of the flap door, for example, can be used to maintain in-cabin CO₂ concentration at and/or below the threshold concentration of CO₂.

In accordance with an embodiment, the open-loop control can have multiple variations. For example, a first variation may be best for protection in which the system 100 can close the flap door beyond an angle for the equilibrium at the threshold, which will allow the in-cabin CO₂ concentration to increase as time goes. This open-loop control mode can also help prevent relatively high concentration of air pollutants from penetrating into cabin for relatively short intervals. Another variation of the open-loop control can be to gradually close and open the flap door angle near equilibrium (i.e., at or near the CO₂ concentration), which can allow the air in the vehicle cabin to be maintained with minimum pollutant concentrations while not exceeding the threshold CO₂ concentration. In addition, different variations in the flap door opening and closing strategy can be employed. For example, strategies can be developed through multiple vehicle tests to allow fast or slow air exchange depending on the need.

In accordance with an embodiment, a cabin flow model adopt flow resistance method can be employed, which is similar to thermal resistance method in heat transfer. For example, the flow resistance within a vehicle can be obtained indirectly by measuring in-cabin concentration and fitting results to equation or algorithm that controls the air intake flow as disclosed herein. Once, for example, one or more of the resistances are known and confirmed, the open-loop control method can then be used with minimum error.

In accordance with one embodiment, the closed loop concentration system includes a CO₂ sensor to conduct feedback control of flap door with the threshold in-cabin CO₂ value. Simply applying the flap can undershoot or overshoot target CO₂ concentration. For example, an air quality map can give location information and expected arrived times in the location where cabin air control system should react in response to high concentration of pollutants. Upon leaving the area of high pollutant concentrations, for example, the close loop control system can be undone, and the flap door can be opened.

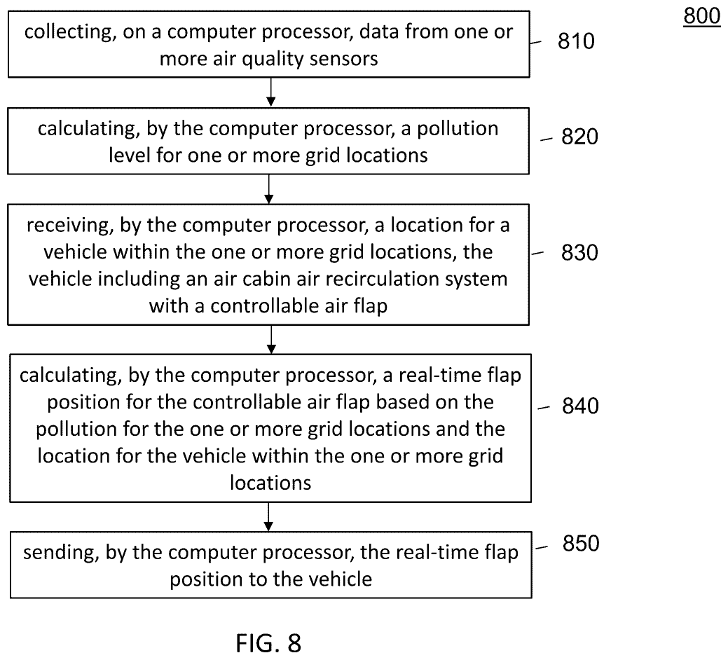

FIG. 8 is flowchart of method 800 for adaptive cabin air quality control in accordance with an embodiment. As shown in FIG. 8, in step 810, data from one or more air quality sensors is collected on a computer processor. In step 820, a pollution level for one or more grid locations is calculated by the computer processor. In step 830, a location for a vehicle 300 within the one or more grid locations, the vehicle 300 including an air cabin air recirculation system with a controllable air flap 400 is received by the computer processor. In step 840, a real-time flap position for the controllable air flap 400 based on the pollution for the one or more grid locations and the location for the vehicle 300 within the one or more grid locations is calculated by the computer processor. In step 850, the real-time flap position is sent by the computer processor to the vehicle 300.

In accordance with an embodiment, the data from the one or more air quality sensors is received by the computer processor can be from on-board air quality sensors from one or more vehicles 130. Alternatively, the data from the one or more air quality sensors received by the computer processor can be from one or more stationary air quality sensors positioned in the one or more grid locations. In an embodiment, the data from the one or more air quality sensors received by the computer processor can be from on-board air quality sensors from one or more vehicles 130 and from one or more stationary air quality sensors positioned in the one or more grid locations.

In accordance with an embodiment, the computer processor can be configured to receive an in-cabin CO₂ calculation from the vehicle 300, calculate an updated real-time flap position for the controllable air flap 400 based on the pollution for the one or more grid locations, the location for the vehicle 300, and the in-cabin CO₂ calculation from the vehicle 300, and send the updated real-time flap position to the vehicle 300.

In accordance with an embodiment, the computer processor can be configured to receive an in-cabin CO₂ calculation from the vehicle 300, calculate an updated real-time flap position for the controllable air flap 400 based the in-cabin CO₂ calculation from the vehicle 300, the in-cabin CO₂ calculation including a threshold in-cabin CO₂ concentration, the threshold in-cabin CO₂ configured to determine if the controllable air flap 400 can be opened or closed, and send the updated real-time flap position to the vehicle 300.

In accordance with an embodiment, the computer processor can be configured to receive one or more of a vehicle speed, a number of passengers in the vehicle 300, a cabin volume in the vehicle 300, a fan speed of an air conditioning fan or a percentage of the controllable air flap opening, calculate an updated real-time flap position for the vehicle 300 based the in-cabin CO₂ calculation from the vehicle 300, the in-cabin CO₂ calculation including a threshold in-cabin CO₂ concentration, the threshold in-cabin CO₂ configured to determine if the controllable air flap 400 can be opened or closed, and send the updated real-time flap position to the vehicle 300.

In accordance with an embodiment, the computer processor can be configured to receive an estimated route for the vehicle 300 through the one or more grid locations for the estimated route, calculate a projected real-time flap position for the air intake system of the vehicle 300 based on the pollution for the one or more grid locations, the location for the vehicle 300 within the one or more grid locations, and the estimated route for the vehicle 300 through the one or more grid locations for the estimated route, and send the projected real-time flap position to the vehicle 300.

In accordance with an embodiment, the computer processor can be configured to receive data for a route for the vehicle 300 through the one or more grid locations, calculate a projected real-time flap position for the controllable air flap 400 based on the pollution for the one or more grid locations, the location for the vehicle 300 within the one or more grid locations, and the data for the route for the vehicle 300 through the one or more grid locations, and send the projected real-time flap position to the vehicle 300.

In accordance with an embodiment, the computer processor is a cloud server. Alternatively, one or more of the processes executed by the computer processor of the cloud server 110 can be a computer processor located within the vehicle 300, for example, in combination with the sensor 310. For example, the sensor 310 can include a processor configured to execute one or more of the processes as disclosed herein.

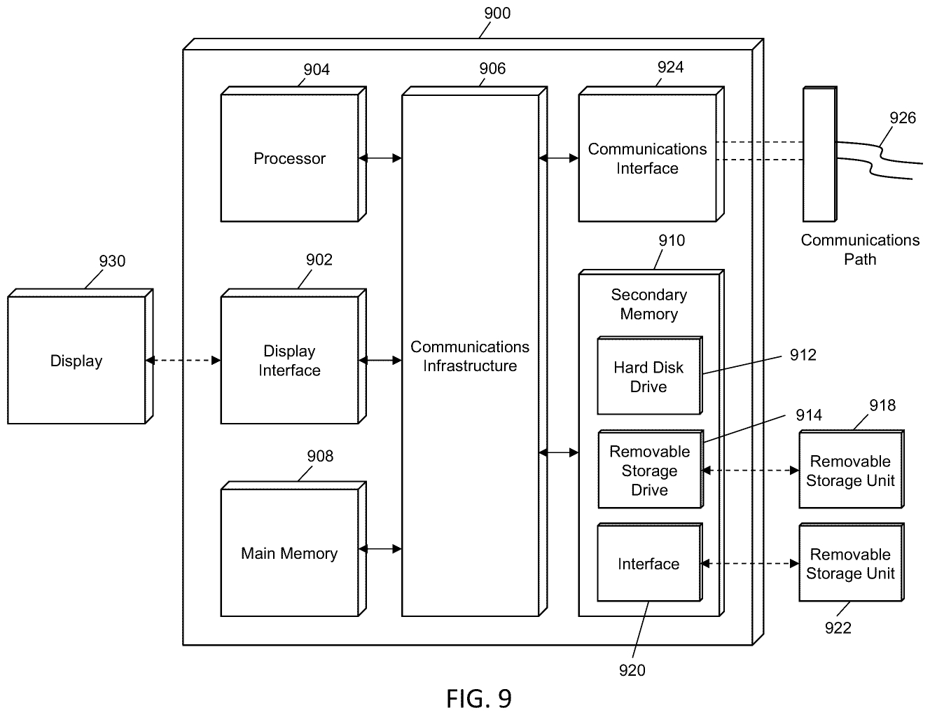

FIG. 9 illustrates a representative computer system 900 in which embodiments of the present disclosure, or portions thereof, may be implemented as computer-readable code executed on hardware. For example, the one or more computer systems 110, 700 associated with the method and system for adaptive cabin air quality control as disclosed herein may be implemented in whole or in part by a computer system 900 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the presently described method and system.

If programmable logic is used, such logic may execute on a commercially available processing platform configured by executable software code to become a specific purpose computer or a special purpose device (for example, programmable logic array, application- specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this representative computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

A processor device 904 may be processor device specifically configured to perform the functions discussed herein. The processor device 904 may be connected to a communications infrastructure 906, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc. Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 1-8, as discussed herein. Accordingly, such computer programs may represent controllers of the computer system 900. Where the present disclosure is implemented using software executed on hardware, the software may be stored in a computer program product and loaded into the computer system 900 using the removable storage drive 914, interface 920, and hard disk drive 912, or communications interface 924.

The processor device 904 may comprise one or more modules or engines configured to perform the functions of the computer system 900. Each of the modules or engines may be implemented using hardware and, in some instances, may also utilize software executed on hardware, such as corresponding to program code and/or programs stored in the main memory 908 or secondary memory 910. In such instances, program code may be compiled by the processor device 904 (e.g., by a compiling module or engine) prior to execution by the hardware of the computer system 900. For example, the program code may be source code written in a programming language that is translated into a lower level language, such as assembly language or machine code, for execution by the processor device 904 and/or any additional hardware components of the computer system 900. The process of compiling may include the use of lexical analysis, preprocessing, parsing, semantic analysis, syntax- directed translation, code generation, code optimization, and any other techniques that may be suitable for translation of program code into a lower level language suitable for controlling the computer system 900 to perform the functions disclosed herein. It will be apparent to persons having skill in the relevant art that such processes result in the computer system 900 being a specially configured computer system 900 uniquely programmed to perform the functions discussed above.

The detailed description above describes embodiments of a method and system for adaptive air quality control. The invention is not limited, however, to the precise embodiments and variations described. Various changes, modifications and equivalents may occur to one skilled in the art without departing from the spirit and scope of the invention as defined in the accompanying claims. It is expressly intended that all such changes, modifications and equivalents which fall within the scope of the claims are embraced by the claims.

What is claimed is:

1. A method for adaptive cabin air quality control, the method comprising:
collecting, on a computer processor, data from one or more air quality sensors;
calculating, by the computer processor, a pollution level for one or more grid locations;
receiving, by the computer processor, a location for a vehicle within the one or more grid locations, the vehicle including an air cabin air recirculation system with a controllable air flap;
calculating, by the computer processor, a real-time flap position for the controllable air flap based on the pollution for the one or more grid locations and the location for the vehicle within the one or more grid locations; and
sending, by the computer processor, the real-time flap position to the vehicle.

2. The method according to claim 1, further comprising:
receiving, by the computer processor, the data from the one or more air quality sensors from on-board air quality sensors from one or more vehicles.

3. The method according to claim 1, further comprising:
receiving, by the computer processor, the data from the one or more air quality sensors from one or more stationary air quality sensors positioned in the one or more grid locations.

4. The method according to claim 1, further comprising:
receiving, by the computer processor, the data from the one or more air quality sensors from on-board air quality sensors from one or more vehicles and from one or more stationary air quality sensors positioned in the one or more grid locations.

5. The method according to claim 1, further comprising:
receiving, by the computer processor, an in-cabin CO₂ calculation from the vehicle;
calculating, by the computer processor, an updated real-time flap position for the controllable air flap based on the pollution for the one or more grid locations, the location for the vehicle, and the in-cabin CO₂ calculation from the vehicle; and
sending, by the computer processor, the updated real-time flap position to the vehicle.

6. The method according to claim 1, further comprising:
receiving, by the computer processor, an in-cabin CO₂ calculation from the vehicle;
calculating, by the computer processor, an updated real-time flap position for the controllable air flap based the in-cabin CO₂ calculation from the vehicle, the in-cabin CO₂calculation including a threshold in-cabin CO₂ concentration, the threshold in-cabin CO₂configured to determine if the controllable air flap can be opened or closed; and
sending, by the computer processor, the updated real-time flap position to the vehicle.

7. The method according to claim 1, further comprising:
receiving, by the computer processor, one or more of a vehicle speed, a number of passengers in the vehicle, a cabin volume in the vehicle, a fan speed of an air conditioning fan or a percentage of the controllable air flap opening;
calculating, by the computer processor, an updated real-time flap position for the vehicle based the in-cabin CO₂ calculation from the vehicle, the in-cabin CO₂ calculation including a threshold in-cabin CO₂ concentration, the threshold in-cabin CO₂ configured to determine if the controllable air flap can be opened or closed; and
sending, by the computer processor, the updated real-time flap position to the vehicle.

8. The method according to claim 1, further comprising:
calculating, by the computer processor, an estimated route for the vehicle through the one or more grid locations for the estimated route;
calculating, by the computer processor, a projected real-time flap position for the air intake system of the vehicle based on the pollution for the one or more grid locations, the location for the vehicle within the one or more grid locations, and the estimated route for the vehicle through the one or more grid locations for the estimated route; and
sending, by the computer processor, the projected real-time flap position to the vehicle.

9. The method according to claim 1, further comprising:
receiving, by the computer processor, data for a route for the vehicle through the one or more grid locations;
calculating, by the computer processor, a projected real-time flap position for the controllable air flap based on the pollution for the one or more grid locations, the location for the vehicle within the one or more grid locations, and the data for the route for the vehicle through the one or more grid locations; and
sending, by the computer processor, the projected real-time flap position to the vehicle.

10. The method according to claim 1, wherein the computer processor is a cloud server.

11. A system for adaptive cabin air quality control, the system comprising:
a processor configured to:
collect data from one or more air quality sensors;
calculate a pollution level for one or more grid locations;
receive a location for a vehicle within the one or more grid locations, the vehicle including an air cabin air recirculation system with a controllable air flap;
calculate a real-time flap position for the controllable air flap based on the pollution for the one or more grid locations and the location for the vehicle within the one or more grid locations; and
send the real-time flap position to the vehicle.

12. The system according to claim 11, wherein the processor is further configured to:
receive the data from the one or more air quality sensors from on-board air quality sensors from one or more vehicles.

13. The system according to claim 11, wherein the processor is further configured to:
receive the data from the one or more air quality sensors from one or more stationary air quality sensors positioned in the one or more grid locations.

14. The system according to claim 11, wherein the processor is further configured to:
receive the data from the one or more air quality sensors from on-board air quality sensors from one or more vehicles and from one or more stationary air quality sensors positioned in the one or more grid locations.

15. The system according to claim 11, wherein the processor is further configured to:
receive an in-cabin CO₂ calculation from an air quality sensor within the vehicle;
calculate updated real-time flap position for the controllable air flap based on the pollution for the one or more grid locations, the location for the vehicle, and the in-cabin CO₂calculation from the vehicle; and
send the updated real-time flap position to the vehicle.

16. The system according to claim 11, wherein the processor is further configured to:
receive an in-cabin CO₂ calculation from the vehicle;
calculate an updated real-time flap position for the controllable air flap based the in-cabin CO₂ calculation from the vehicle, the in-cabin CO₂ calculation including a threshold in-cabin CO₂ concentration, the threshold in-cabin CO₂ configured to determine if the controllable air flap can be opened or closed; and
send the updated real-time flap position to the vehicle.

17. The system according to claim 11, wherein the processor is further configured to:
receive one or more of a vehicle speed, a number of passengers in the vehicle, a cabin volume in the vehicle, a fan speed of an air conditioning fan or a percentage of the controllable air flap opening;
calculate an updated real-time flap position for the vehicle based the in-cabin CO₂ calculation from the vehicle, the in-cabin CO₂ calculation including a threshold in-cabin CO₂ concentration, the threshold in-cabin CO₂ configured to determine if the controllable air flap can be opened or closed; and
send the updated real-time flap position to the vehicle.

18. The system according to claim 11, wherein the processor is further configured to:
calculate an estimated route for the vehicle through the one or more grid locations for the estimated route;
calculate a projected real-time flap position for the air intake system of the vehicle based on the pollution for the one or more grid locations, the location for the vehicle within the one or more grid locations, and the estimated route for the vehicle through the one or more grid locations for the estimated route; and
send the projected real-time flap position to the vehicle.

19. The system according to claim 11, wherein the processor is further configured to:
receive data for a route for the vehicle through the one or more grid locations;
calculate a projected real-time flap position for the controllable air flap based on the pollution for the one or more grid locations, the location for the vehicle within the one or more grid locations, and the data for the route for the vehicle through the one or more grid locations; and
send the projected real-time flap position to the vehicle. server.

20. The system according to claim 11, wherein the computer processor is a cloud
